(19) United States
(12) Patent Application Publication
(10) Pub. No.: US 2024/0296609 A1
(43) Pub. Date: Sep. 5, 2024

(54) COMBINING A GRAPHIC CODE WITH AN IMAGE

(71) Applicant: Hewlett-Packard Development Company, L.P., Spring, TX (US)

(72) Inventor: Gideon AMIR, Ness Ziona (IL)

(73) Assignee: Hewlett-Packard Development Company, L.P., Spring, TX (US)

(21) Appl. No.: 18/550,618

(22) PCT Filed: Mar. 15, 2021
(86) PCT No.: PCT/US2021/022330

§ 371 Date: Sep. 14, 2023

(51) Int. Cl. G06T 11/60; G06K 19/06

(52) U.S. Cl. CPC G06T 11/60; G06K 19/06037; G06K 19/06103

(57) ABSTRACT

In an example, a method includes receiving a Quick Response (QR) code including a plurality of dark blocks and a plurality of light blocks. For each of a first set of blocks, a central pixel or a plurality of central pixels, and a plurality of outer pixels may be defined. The QR code may be combined with an image, the image having an area to be co-located with the QR code with pixel dimensions corresponding to pixel dimensions of the QR code, to form a combined image, wherein combining the QR code and the image may include, at locations of the combined image corresponding to outer pixel locations of the QR code, using pixel data from the image as pixel data for the combined image.

### BACKGROUND

Machine readable graphic codes are representations of data which are readable by a machine via optical means. Examples of machine readable graphic codes are Quick Response (QR) codes and barcodes.

### BRIEF DESCRIPTION OF THE DRAWINGS

Non-limiting examples will now be described with reference to the accompanying drawings, in which:

FIG. 1 shows a flowchart of an example method of producing a combined image and graphic code;

FIG. 1A shows a schematic representation of part of the example method of FIG. 1;

FIG. 1B shows a schematic representation of another part of the example method of FIG. 1;

FIG. 2 shows a flowchart of another example method of producing a combined image and graphic code;

FIG. 3 shows a schematic representation of an example tangible-machine readable medium and a processor for producing a combined image and graphic code;

FIG. 4 shows an schematic representation of an example apparatus;

FIG. 5 shows a flowchart of an example method of producing a combined graphic code;

FIG. 6 shows a schematic graphical representation of a method of producing a combined graphic code;

FIG. 7 shows an example of a combined QR code.

### DETAILED DESCRIPTION

Machine readable graphic codes optically represent data for reading by a device, such as a barcode scanner, or a camera in combination with a processor including a suitable program for decoding the code. In some examples, a machine readable graphic code may be printed onto a print medium or substrate and affixed to an item. The code may, in some examples, encode information about the item to which it is affixed.

In examples, machine readable graphic codes include a plurality of relatively light areas (‘light areas’) and a plurality of relatively dark areas (‘dark areas’). The information encoded by the code is contained in the positioning of the light areas and the dark areas. Such machine readable graphic codes may be referred to as binary machine readable graphic codes. Example types of machine readable codes are one-dimensional, 1D, barcodes, and two-dimensional, 2D, barcodes. 2D barcodes may also be referred to as matrix codes. An example 2D barcode may represent data via a plurality of areas which may be rectangles, dots, hexagons, and/or other geometric patterns. In an example, a 2D barcode, or matrix code, may include a plurality of black areas separated by a plurality of white areas, wherein the information encoded by the code is determinable from the shaping and the spacing of the areas. An example of a 2D barcode is a Quick Response, QR, code. Other examples of 2D barcodes are Data Matrix, DM, codes and DotCodes.

A machine readable code such as a QR code may include a plurality of function patterns, which are separate from an encoding region of the QR code that includes encoded data. The function patterns may be to enable detection of the QR code by a QR code reader device and improve readability of the QR code. For example a QR code may include one position detection pattern along with surrounding separator patterns, in each of three corners of a 2D code having four corners, in order to provide an alignment calibration to a machine reading the code. A QR code may also include alignment patterns, the number of which may be a function of the size (in modules) of the QR code with more alignment patterns being included for larger (higher version) QR codes. The alignment patterns may maintain readability of the QR code by a reader for cases of QR image deformation, either physically or due to the capturing angle. A QR code may also include two timing patterns to locate the rows and columns of the encoded data.

A graphic code may include error correction features, such as redundant information-carrying areas of the code, which act to correct errors in reading the code should other areas of the code be unreadable. The provision of error correction features may allow for areas of a generated code to be omitted or modified without rendering the code unreadable.

In some examples, a machine readable graphic code may form part of a mobile payment system. For example, a user may scan a machine readable code such as a QR code with their phone to transfer money to the owner of the QR code. Combining a graphic code with an image, such as a recognizable logo, may help to prevent fraud and improve security in such systems.

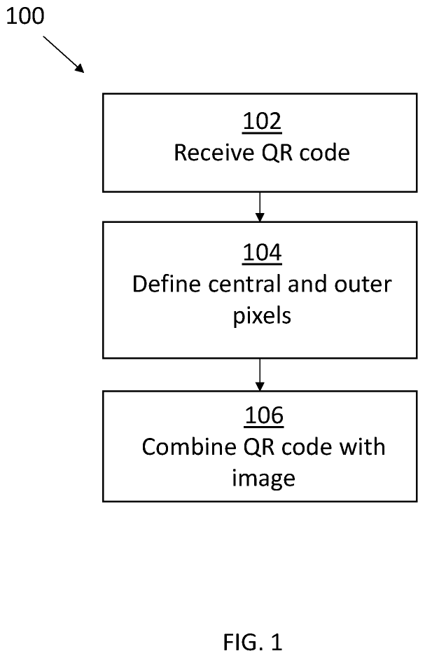

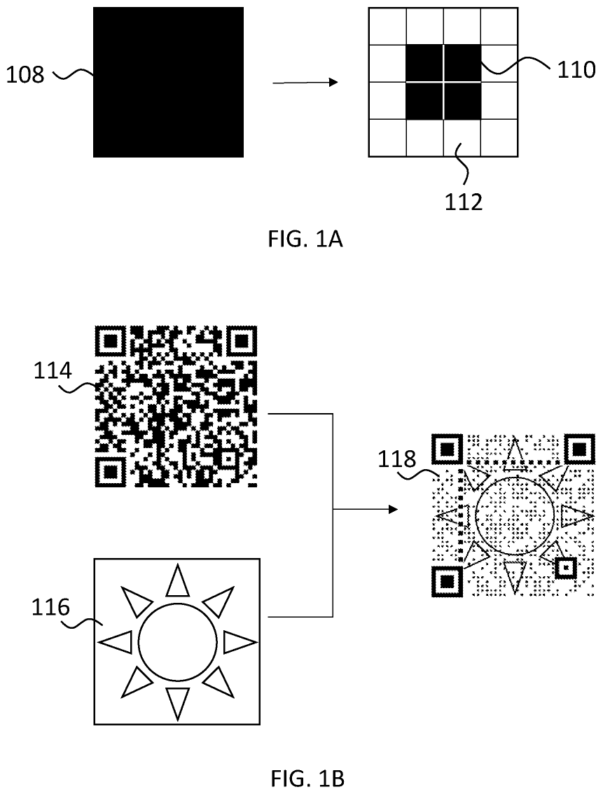

FIG. 1 shows an example method 100, which may be a computer implemented method carried out by at least one processor, and/or may be a method for producing a combined image and machine readable graphic code. The method includes, at box 102, receiving a QR code including a plurality of dark blocks and a plurality of light blocks. Each of the blocks may represent one bit of encoded data, or error correction data, of the QR code and may be represented as black and white square blocks in an encoding region of the QR code.

Box 104 includes, for each of a first set of blocks of the QR code, defining a central pixel or a plurality of central pixels, and a plurality of outer pixels. For example, as shown in FIG. 1A, a square block 108 of the received QR code may include, or be sub-divided into a number of pixels, for example 4×4 pixels. 4 pixels (2×2) located in the middle of the block may then be categorized as central pixels 110 and 12 pixels forming a border of 1 pixel width surrounding the central pixels may be defined as outer pixels 112. In some examples the block may be divided into a different number of pixels. For example, the block may be divided into an n×n square of pixels where n≥3 such that there is at least one central pixel and a surrounding border of outer pixels that is at least one pixel wide. In some examples, the first set of blocks may include all blocks of the QR code. In some examples, the first set of blocks may comprise blocks of the QR code located in the encoding area. i.e. blocks of the QR code representing encoded data rather than e.g. function patterns. In some examples the first set of blocks may include all of the QR code blocks located in the encoding area, or a sub-set of these blocks representing an area which is to be combined with an image (e.g. a watermark or logo to be co-located with one area of the QR code).

Box 106 comprises combining the QR code with an image, the image having an area to be co-located with the QR code, the image area having pixel dimensions corresponding to pixel dimensions of the QR code, to form a combined image. FIG. 1B shows an example of a QR code 114 being combined with an image 116 to form a combined image 118 in accordance with box 106 of method 100. In some examples the image has the same dimensions as the QR code. In some examples, the method may include receiving an image and scaling and/or cropping the image to match the dimensions (in pixels) of the QR code. In some examples, the method may include scaling the QR code, for example such that the dimensions of the QR code match the image. In some examples, the image may be larger than the QR code and the QR code may be combined with a portion or area of the image that matches the QR code pixel dimensions.

In some examples, the QR code may be scaled by sub-dividing each blocks into multiple pixels. For example a 1 pixel block could be sub-divided into 4×4 pixels in order to define central and outer pixels as shown in FIG. 1A. For e.g. a 37×37 block size QR code this would provide pixel dimensions of 148×148. Sub-dividing each of those pixels by a further factor n would then scale the QR code further. For example sub-dividing each pixel by a factor of n=10 would provide pixel dimensions of 1480×1480. Scaling the QR code in this way can increase the resolution and quality of the combined QR code and image.

In some examples, the QR code could be scaled to use any integer n×n pixel square to represent each block, e.g. 5×5, 6×6, 7×7 etc. In some examples, the central and outer pixels may be determined by applying conditions such that the central pixels are centred in the block and are also centred with respect to a timing pattern of the QR code. Another condition may be that the width of the central pixels in one direction is as small as possible, whilst being equal to or larger than the total width of the outer pixels (i.e. the outer pixels on each side of the central pixels) in that direction. For example the width of the outer pixels may be calculated by dividing the total width of the block in pixels by 4 and then rounding down to the nearest integer. The width of the central area in pixels would then be the block width minus 2× the above calculated result. E.g. for a block of 5×5 pixels, the central pixels may be a 3×3 square with a surrounding border of outer pixels 1 pixel wide (1,3,1). For a block of 7×7 pixels, the central pixels may be a 5×5 square with a 1 pixel wide border (1,5,1), for a block of 8×8 pixels the central pixels may be a 4×4 square with a surrounding border of outer pixels 2 pixels wide (2,4,2).

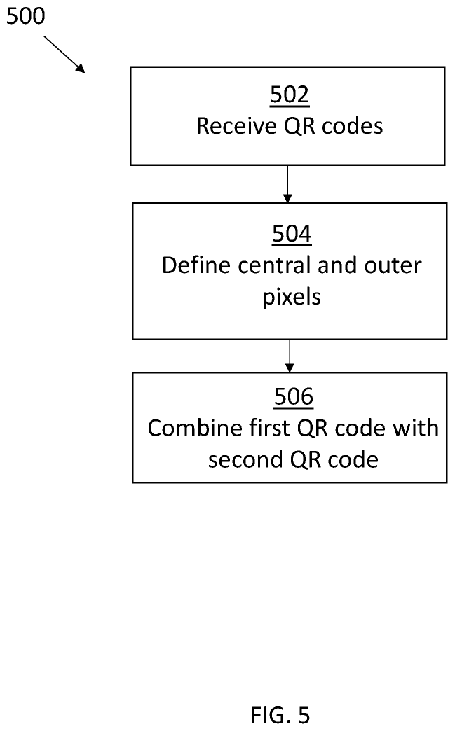

The image to be combined with the QR code may comprise an array of pixels where each pixel is associated with image data also referred to herein as pixel data comprising a value or a plurality of values such as color, lightness, saturation etc. The image data may include print data to enable the image to be printed by a printing apparatus. In some examples, as described below in relation to FIGS. 5 to 7, the image itself may also be a graphic code, such as a QR code.

Combining the QR code with the image at box 106 includes, at locations of the combined image corresponding to outer pixel locations of the QR code, using pixel data from the image as pixel data for the combined image. That is, at pixel locations which correspond to an outer pixel of the QR code, the QR code pixel data is replaced with pixel data of the corresponding pixel of the image, i.e. image pixel data is used, rather than QR pixel data, in the combined image at these pixel locations.

Removing the outer pixels of the QR code blocks whilst still maintaining readability of the QR code is possible, since in practice the centre of each QR block is the area which is focused on/read by a QR reader, since QR code timing patterns, which enable detection of columns and rows of the QR code by the reader, are aligned to the centres of each QR block. Therefore, the outer pixels of each block can be replaced with image data whilst maintaining readability of the QR code.

In some examples, combining the QR with the image at box 106 may further include associating central pixels of each dark block of the first set with a first lightness threshold LTₐ and associating central pixels of each light block of the first set with a second lightness threshold LT_{b}. The lightness thresholds may be defined on a lightness scale (e.g. using a hue, saturation, lightness color system) e.g. from black (low lightness) to white (high lightness). The first lightness threshold is set at a darker level than the second lightness threshold in order to provide a contrast between areas of the combined image representing dark and light blocks of the QR code. In some examples, combining the QR with the image may include receiving the image and converting it into HSL format (e.g. from RGB or another color format). For the purposes of explanation, we use herein an example scale with 0 representing black (low lightness level) and 1 representing white (high lightness level). In some examples a different scale may be used to represent lightness e.g. with 1 representing black and 0 representing white. The central pixels of each dark block, which are associated with lightness threshold LTₐ may be defined as type a pixels. The central pixels of each light block, which are associated with lightness threshold LT_{b} may be defined as type b pixels. The outer pixels, which, in the example of FIG. 1, do not have an associated lightness threshold, may be defined as type c pixels.

In some examples, box 106 may further include, at locations of the combined image corresponding to central pixel locations of the QR code, applying the associated lightness thresholds, such that each pixel of the combined image that corresponds to a central pixel of a dark block is darker (i.e. closer to black) than the first lightness threshold and each pixel of the combined image that corresponds to a central pixel of a light block is lighter (i.e. closer to white) than the second lightness threshold. Applying the lightness threshold to a particular image pixel may comprise determining that the lightness level of that pixel already passes the threshold and if so leaving the lightness level of that pixel unmodified, or determining that the lightness level of that pixel does not pass the threshold, and in response modifying a lightness level of that pixel so that it passes the threshold. For example, modifying the lightness level may comprise modifying a lightness level represented by pixel data of the particular image pixel to equal the lightness threshold value (i.e. applying the minimum change that will allow the pixel to pass the threshold).

For example, on a lightness scale with black represented by 0 and white represented by 1, the first lightness threshold may be set at e.g. 0.3 such that pixels associated with the first lightness threshold should have a lightness value less than or equal to 0.3 once the threshold is applied. In this case, an image pixel with a lightness value of 0.2 would pass the threshold and an image pixel with a lightness value of 0.4 would not pass the threshold and would then be adjusted to a value of 0.3. The second lightness threshold may be set at e.g. 0.7 such that pixels associated with the second lightness threshold have a lightness value greater than or equal to 0.7 once the threshold is applied. In other examples, the lightness thresholds may be set at different levels.

Applying thresholds to the central pixels of the combined image and QR code helps to ensure that the QR code is still be readable whilst avoiding excess modification of the image, since image pixels that have a lightness level which already passes the threshold will not be adjusted. This helps to retain readability of the QR code whilst also providing a clear image. This may help to increase security and reduce fraud as the image can help a user to verify that the QR code is authentic before scanning it.

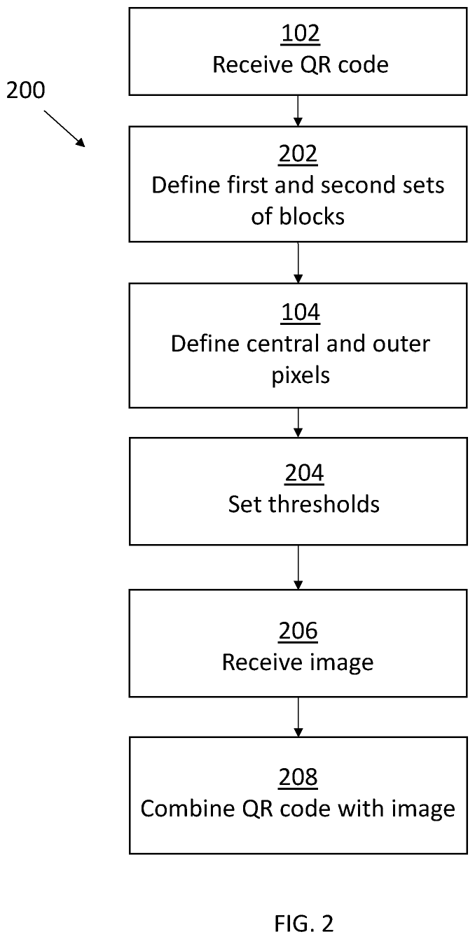

FIG. 2 shows another method 200 of combining an image with a QR code. The method includes, at box 102, receiving a QR code, as described above. Method 200 also includes box 202 which includes defining a first plurality of blocks representing encoded data as the first set of blocks and defining a second plurality of blocks representing a function pattern as a second set of blocks. The function pattern may be a position detection pattern and its separators, an alignment pattern or a timing pattern or a combination of these patterns. Box 202 may include detecting some or all of the function patterns in the QR code and tagging these as forming the second set of blocks. The received QR code may include function patterns located at pre-defined block locations (particular rows and/or columns of blocks) in the QR code. In some examples, box 202 may include detecting the function patterns by determining expected block locations of the function patterns associated with a version of the QR code, since for a particular QR code version, the function patterns may be located at pre-defined locations, for example as defined in ISO standard ISO/IEC 18004. For example, a version 5 QR code may have 37×37 blocks with an alignment pattern located at (30,30) where (0,0) is the top-left corner block and timing patterns located at (0,6) and (6,0).

Method 200 includes box 104, which comprises defining central and outer pixels for the first set of blocks, as described above. Method 200 also includes box 204 which includes associating central pixels of each dark block of the first set with a first lightness threshold LTₐ and associating central pixels of each light block of the first set with a second lightness threshold LT_{b} as described above. Box 204 also includes associating pixels of each dark block of the second set with a third lightness threshold LT_{d} and associating pixels of each light block of the second set with a fourth lightness threshold LTₑ. The third lightness threshold is set at a darker level than the fourth lightness threshold, in order to provide a contrast between the dark and light blocks of the second set so that the function patterns of the QR code can be read by a reader device. Pixels of dark blocks of the second set may be defined as type d pixels and pixels of light blocks of the second set may be defined as type e pixels.

In the method of FIG. 2, the first and third thresholds are associated with dark blocks and define a maximum lightness level (i.e. image pixels are darker than or equal to this value to pass the threshold). The second and fourth thresholds are associated with light blocks and set a minimum lightness level (i.e. image pixels are lighter than or equal to this value to pass the threshold).

In some examples, the third lightness threshold is set at a darker level than the first lightness threshold and the fourth lightness threshold is set at a lighter level than the second lightness threshold. i.e. LT_{d}<LTₐ<LT_{b}<LTₑ. For example on a lightness scale with black represented by 0 and white represented by 1, the first lightness threshold may be set at e.g. 0.3 and the second lightness threshold may be set at e.g. 0.7. The third lightness threshold may then be set at e.g. 0.2 and the fourth lightness threshold may be set at e.g. 0.8. In some examples, the first lightness threshold may be set at a lightness level between 0.1 and 0.4 and the second lightness threshold may be set at a lightness level between 0.6 and 0.9. The third lightness threshold may be set at a lightness level between 0 and 0.3 and the fourth lightness threshold may be set at a lightness level between 0.7 and 1.

The third and fourth thresholds may therefore be set to provide greater contrast between type d and type e areas than between type a and type b areas. A reading device may rely on function patterns to detect a QR code and determine where to look for encoded data within the QR code. The function patterns of the QR code may include less built-in redundancy than within the encoding area of the QR code. Therefore greater contrast between type d and type e areas may provide greater readability of the QR code. Type a and b pixels may represent encoded data in an encoding area of the QR code. Lower contrast can be used in this area since, due to built-in redundancy of the QR code, a reading device does not need to detect light and dark blocks with as high a level of accuracy as for the function pattern areas. Therefore, in the encoding area smaller adjustments can be made to the lightness levels of the image pixels, thereby better preserving the image. For example, the received QR code may include an amount of redundancy or an error correction level H in the encoded data, which may help to maintain readability of the encoding area of the QR code even if a portion of the QR code is obscured or unreadable. In some examples the method may include providing the received QR code with an error correction level of between 20% and 50%. In some examples an error correction level of 30% may be used. Using an error correction level in this way may help to maintain readability of the QR code after combining with an image as described herein.

Box 206 of method 200 includes receiving an image to be combined with the QR code. The image may be received in a color format such as RGB, CMYK, L*a*b* or HSL. In examples where the image is received in a color format other than HSL, block 206 may also include converting the color format of the image to HSL. Converting the image to HSL enables the lightness levels of the image to be adjusted independently of the color tone, or other parameters of the image, thereby better preserving the original colors of the image when modifying the lightness levels.

Box 208 of method 200 includes combining the received QR code with the received image in order to form a combined QR code and image as described above in relation to box 106. Box 208 also includes applying the associated third and fourth lightness thresholds LT_{d} and LTₑ such that each pixel of the combined image that corresponds to a dark block of the second set of blocks (type d) is darker than the third threshold and wherein each pixel of the combined image that corresponds to a light block of the second set of blocks (type e) is lighter than the fourth lightness threshold.

In some examples, combining the QR code with the image at box 208 may include adjusting or modifying saturation values of the pixel data in addition to lightness values. In some cases, for large lightness modifications, the color of a pixel may also appear to change. For example, in some cases, where a very light pixel (e.g. off-white) of the image corresponds to a dark block of the QR code, a small amount of color in the very light pixel may be emphasized when modifying the lightness of that pixel to be darker independently of saturation e.g. in HSL format. Therefore, the method may also include modifying saturation values of the pixels. For example, the method may include reducing saturation values of the image pixels as a function of lightness to provide a non-linear reduction of saturation values of the image.

In some examples, combining the QR code with the image at box 208 may include converting the combined image and QR code into a particular color format. For example, where the image has been converted to HSL format, the combine image and QR code may be converted back to the original image format (e.g. RGB, CMYK). This may enable easier or higher quality printing of the combined QR code.

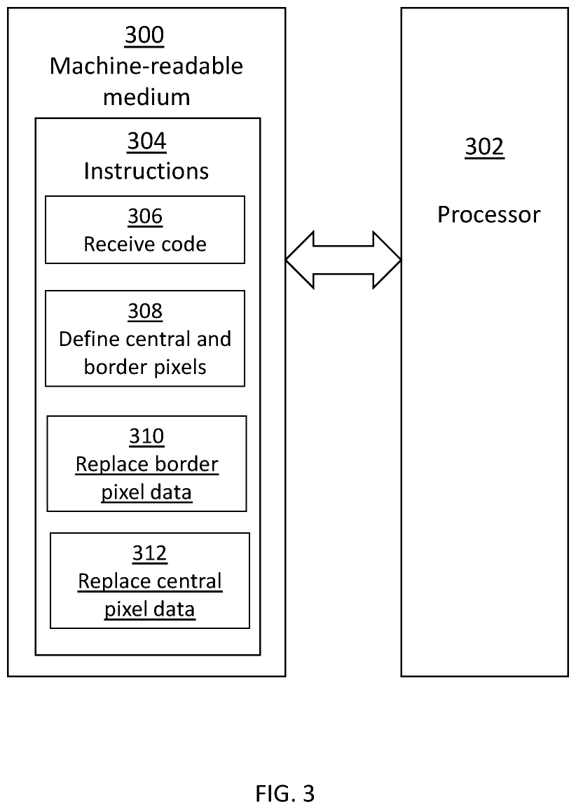

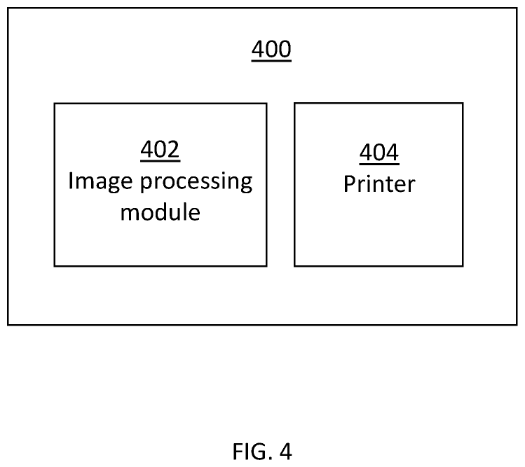

FIG. 3 shows a tangible machine-readable medium 300 in association with a processor 302. In some examples, the machine-readable medium may include instructions to perform the method 100 of FIG. 1. In some examples, the machine-readable medium 300 may include instructions to perform the method 200 of FIG. 2. In some examples, the machine-readable medium 300 may include instructions to perform the method of FIG. 5. In some examples, the machine-readable medium 300 may form part of an apparatus as described below in relation to FIG. 4.

The machine-readable medium 300 includes a set of instructions 304 which when executed by the processor 302 cause the processor 302 to, at instructions 306, receive a graphic code including a plurality of dark blocks and a plurality of light blocks, representing encoded data. Instructions 308 cause the processor to represent each encoded data block as an array of pixels including a central pixel, or a plurality of central pixels and a plurality of border pixels, wherein the border pixels surround the central pixels. Instructions 310 cause the processor to replace pixel data of the border pixels with corresponding pixel data from an image having the same dimensions as the graphic code. Instructions 312 cause the processor to replace pixel data of the central pixels with modified corresponding pixel data from the image, wherein modifying the corresponding pixel data from the image includes applying a lightness threshold to the image pixel data, wherein for replaced central pixels located in a dark block of the graphic code, the lightness threshold comprises a first lightness threshold, which defines a maximum lightness level, and for replaced central pixels located in a light block of the graphic code, the lightness threshold comprises a second lightness threshold, which defines a minimum lightness level. That is, for each dark block the first lightness threshold is applied such that each central pixel of a dark block is darker than (lower lightness level) or equal to the applied threshold and for each light block the second lightness threshold is applied such that each central pixel of a light block is lighter than (higher lightness level) or equal to the applied threshold.

The machine-readable medium 300 may also include further instructions, which, when executed by the processor 302 cause the processor 302 to detect a plurality of dark blocks and a plurality of light blocks that represent a function pattern of the graphic code.

The machine-readable medium 300 may also include instructions to associate a third lightness threshold with dark blocks of the function pattern and associate a fourth lightness threshold with light blocks of the function pattern.

The machine-readable medium 300 may also include instructions to replace pixel data of the function patterns with modified corresponding pixel data from the image, wherein modifying the corresponding pixel data from the image includes applying the third and fourth lightness thresholds to image pixel data at locations corresponding to the function pattern. The third lightness threshold may define a maximum lightness level for dark blocks and may be set at a lower lightness level than the first lightness threshold. The fourth lightness level may define a minimum lightness level for light blocks and may be set at a higher lightness level than the second lightness threshold.

FIG. 4 shows an apparatus 400, which may be a printing apparatus. The apparatus 400 may be to perform the method of FIG. 1 or FIG. 2. The apparatus 400 may be to perform the method of FIG. 5. The apparatus 400 includes an image processing module 402 and a printer 404. The image processing module 402 may include a tangible machine-readable medium and a processor. For example, the image processing module 402 may include a machine readable-medium 300 and processor 302 as described above in relation to FIG. 3.

In the example shown in FIG. 4, image processing module 402 is to receive a quick response (QR) code and an image; wherein each pixel location of the QR code corresponds to a pixel location of the image. In some examples the image processing module may be to scale the QR code, scale/crop the image or add blank space around the image so that each pixel location of the QR code corresponds to a pixel location of the image.

For each of a first set of blocks of the QR code, the image processing module 402 is to define a central pixel or a plurality of central pixels, and a plurality of outer pixels, wherein the outer pixels surround the central pixels. The image processing module 402 may define a first plurality of blocks representing encoded data as the first set of blocks. The image processing module 402 may also define a second plurality of blocks representing a function pattern as a second set of blocks.

The image processing module 402 is further to combine the QR code with the image, wherein combining the QR code with the image includes: for pixel locations corresponding to outer pixels (type c), using pixel data of the image as combined pixel data; for pixel locations corresponding to central pixels (type a or type b), applying a lightness threshold to the pixel data of the image, wherein the lightness threshold is based on whether that location corresponds to a light block (type b) or a dark block (type a) of the QR code, to provide combined pixel data.

Applying a lightness threshold may include: for a central pixel of a dark block of the first set (type a), applying a maximum lightness threshold (LTₐ) by adjusting a lightness level of image pixels with a lightness level above the maximum lightness threshold to be below or equal to the maximum lightness threshold; for a central pixel of a light block of the first set (type b), applying a minimum lightness threshold (LT_{b}) by adjusting a lightness level of image pixels with a lightness level below the minimum lightness threshold to be above or equal to the minimum lightness threshold.

Combining the QR code with the image may further include for pixel locations corresponding to dark blocks of the second set of blocks (type d), applying a maximum lightness threshold (LT_{d}), which is lower than the maximum lightness threshold (LTₐ) associated with the first set of blocks; and for pixel locations corresponding to light blocks of the second set of blocks (type e), applying a minimum lightness threshold (LTₑ), which is higher than the minimum lightness threshold (LT_{b}) associated with the first set of blocks.

The image processing module 402 may be to send the combined image and QR code to printer 404, for printing of the combined image and QR code.

FIG. 5 shows another example method 500 which is a method for combining two or more QR codes. The method 500 may be performed by a processor in association with a non-transitory machine readable medium such as processor 302 and machine-readable medium 400, or by an apparatus such as apparatus 400. The method 500 is similar to the method 100 described above, wherein the received QR code is a first QR code and the image is a second QR code.

Box 502 of method 500 includes receiving the first QR code as described above with relation to box 102. Box 502 also includes receiving a second QR code. Box 504 comprises defining central and outer pixels of the first QR code as described above in relation to box 104. Box 504 also includes defining central and outer pixels of the second QR code in a similar manner.

Box 506 of method 500 comprises combining the first QR code with the second QR code to form a combined QR code. In the combined QR code, the second QR code is spatially offset from the first QR code by a pre-defined offset, relative to a timing pattern of the first QR code. The spatial offset is defined such that central pixels of the second QR code correspond to outer pixels of the first QR code and vice versa.

Combining the first QR code with the second QR code includes, at locations of the combined image corresponding to outer pixel locations of the first QR code, using pixel data from the second QR code as pixel data for the combined image. That is, at pixel locations which correspond to an outer pixel of the QR code, the QR code pixel data is replaced with pixel data of a corresponding pixel of the second QR code. The pixel of the second QR code defined as the relevant corresponding pixel is defined with a pre-defined spatial offset relative to the first QR code such that one, or a plurality of outer pixels of the first QR code correspond to central pixels of the second QR code. In this way two independent QR codes can be combined or co-located. The timing pattern of the first QR code may be used in the combined image. In order to read the second QR code, a reader could measure the timing pattern and then apply the pre-defined spatial offset in order to detect the blocks of the second QR code, which would be located within the outer pixels of the first QR code.

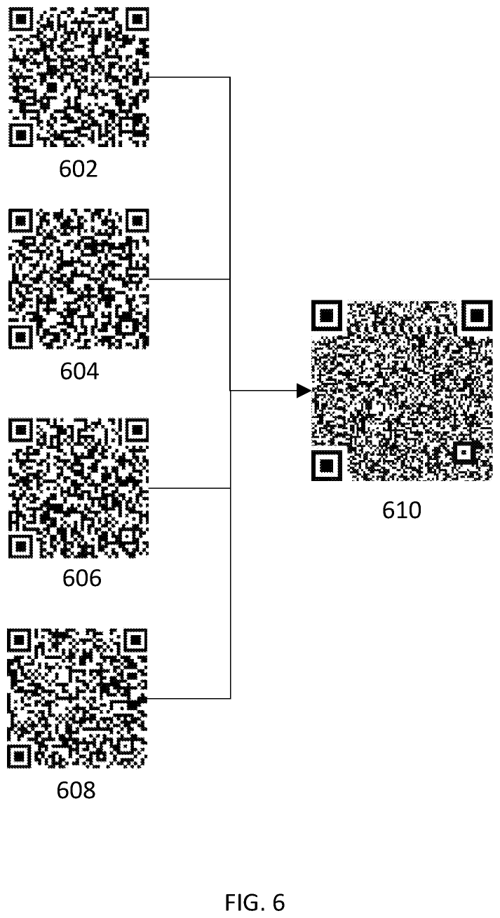

In some examples a plurality of QR codes may be combined together in this way. For example, four QR codes may be combined together, as shown in FIG. 6. In this example the first QR code 602 has central pixels which align with block centres, as defined by timing patterns of the first QR code. Each of the second, third and fourth QR codes, 604, 606 and 608 respectively have a spatial offset applied, such that the central pixels of each of those codes are offset relative to the central pixels of the first QR code and relative to each other. Therefore, when the QR codes are combined, the central pixels of the first QR code 602 correspond to outer pixels of the second, third and fourth QR codes 604-608. Likewise, the central pixels of the second QR code 604 correspond to outer pixels of the first, third and fourth QR codes 602, 606 and 608. Central pixels of the third QR code 606 correspond to outer pixels of the first, third and fourth QR codes 602, 604 and 608 and central pixels of the fourth QR code 608 correspond to outer pixels of the first, second and third QR codes 602, 604 and 606. In this way, all four QR codes can be combined without overlap of their central pixels. The outer pixels of the first QR code are replaced by central pixels of the other three QR codes in the combined QR code 610.

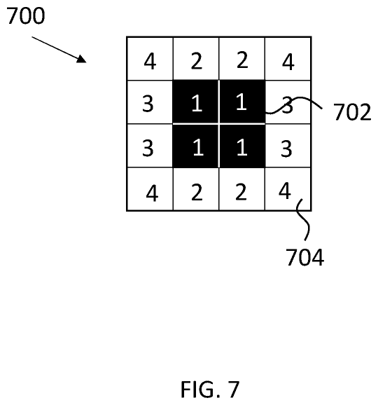

FIG. 7 shows an example block 700 of a combined QR code such as combined QR code 610. In the example shown in FIG. 7, block 700 has been sub-divided into 4×4 sub-areas. In the example of FIG. 7, each sub-area represents one pixel, but it will be appreciated that in other examples, each sub-area could include a plurality of pixels. For example, central pixels 702 of the block 700 may comprise pixels of the first QR code 602. Outer pixels 704 may include pixels that correspond to central pixels of the second, third and fourth QR codes 604-608. The central pixels of the second QR code 604 are offset from the central pixels of the first QR code 602 by a vertical offset of 2 pixels with no horizontal offset. The central pixels of the third QR code 606 are offset from the central pixels of the first QR code 602 by a horizontal offset of 2 pixels with no vertical offset, and the central pixels of the fourth QR code are offset from the central pixels of the first QR code by a horizontal offset of 2 pixels and a vertical offset of 2 pixels. In other examples, other pre-defined offsets may be used for the additional QR codes such that the centres of blocks of the additional QR codes are out of phase with each other and with the first QR code (wherein a phase of the first QR code is defined, for example, by a timing pattern of the first QR code).

In examples where the block 700 is divided into a different number of pixels, different offsets may be used. For example, for a first QR code with central pixels of n×n and an offset of x=0, y=0, three other QR codes may have applied offsets relative to the first QR code of x=n, y=0; x=0, y=n and x=n, y=n (where x represents a horizontal offset and y represents a vertical offset).

A QR reader, can therefore read all four QR codes by knowing the offsets and modifying the timing data received from the timing pattern of the QR code. The timing pattern used in the combined QR code may be the timing pattern of the first QR code. For example, the timing pattern of the first QR code may be tagged as a second set of blocks as described above, which is then left unmodified in the combined QR code. In order to read the offset QR codes, this timing data may be modified by separately applying each of the offsets to the timing data. In the examples shown in FIGS. 6 and 7, four QR codes are combined but in other examples different numbers of QR codes may be combined by e.g. sub-dividing each block into a different numbers of sub-areas and using different offsets. In some examples, all of the outer pixels may be replaced with central pixels of offset QR codes. In other examples a subset of the outer pixels may be replaced with central pixels of offset QR codes, e.g. with other outer pixels being left blank.

Combining QR codes in this way enables readers which know the pre-defined offsets used to read the additional QR codes, which are out of phase with the timing pattern of the combined QR code. I.e. the first QR code can encode data readable by any standard QR reader and the additional QR codes can encode data readable with a specialist application which is programmed to look for the relevant offsets e.g. to access further information or provide a security check.

The present disclosure is described with reference to flow charts and/or block diagrams of the method, devices and systems according to examples of the present disclosure. Although the flow diagrams described above show a specific order of execution, the order of execution may differ from that which is depicted. Boxes described in relation to one flow chart may be combined with those of another flow chart. It shall be understood that each flow and/or box in the flow charts and/or block diagrams, as well as combinations of the flows and/or diagrams in the flow charts and/or block diagrams can be realized by machine readable instructions.

It shall be understood that some blocks in the flow charts can be realized using machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode. Further, some teachings herein may be implemented in the form of a computer software product, the computer software product being stored in a storage medium and comprising a plurality of instructions for making a computer device implement the methods recited in the examples of the present disclosure.

The words “including” and “comprising” do not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

What is claimed is:

1. A method comprising:
receiving a Quick Response (QR) code including a plurality of dark blocks and a plurality of light blocks;
for each of a first set of blocks, defining a central pixel or a plurality of central pixels, and a plurality of outer pixels;
combining the QR code with an image, the image having an area to be co-located with the QR code with pixel dimensions corresponding to pixel dimensions of the QR code, to form a combined image, wherein combining the QR code and the image comprises:
at locations of the combined image corresponding to outer pixel locations of the QR code, using pixel data from the image as pixel data for the combined image.

2. A method according to claim 1, the method further comprising:
associating central pixels of each dark block of the first set with a first lightness threshold and associating central pixels of each light block of the first set with a second lightness threshold; and
wherein combining the QR code and the image includes:
at locations of the combined image corresponding to central pixel locations of the QR code, applying the associated lightness thresholds, such that each pixel of the combined image that corresponds to a central pixel of a dark block is darker than the first lightness threshold and each pixel of the combined image that corresponds to a central pixel of a light block is lighter than the second lightness threshold.

3. A method according to claim 2, the method further comprising defining a first plurality of blocks representing encoded data as the first set of blocks and defining a second plurality of blocks representing a function pattern as a second set of blocks.

4. A method according to claim 3, the method further comprising associating pixels of each dark block of the second set with a third lightness threshold and associating pixels of each light block of the second set with a fourth lightness threshold, and
wherein combining the QR code with the image further includes:
applying the associated lightness thresholds such that each pixel of the combined image that corresponds to a dark block of the second set of blocks is darker than the third threshold and wherein each pixel of the combined image that corresponds to a light block of the second set of blocks is lighter than the fourth lightness threshold.

5. A method according to claim 4, wherein the third lightness threshold is set at a darker level than the first lightness threshold and wherein the fourth lightness threshold is set at a lighter level than the second lightness threshold.

6. A method according to claim 1, wherein defining a central pixel or a plurality of central pixels, and a plurality of outer pixels includes subdividing each of the first set of blocks into a square of n by n pixels where n is greater than or equal to 3.

7. A method according to claim 1, the method further comprising scaling the received QR code by multiplying the number of pixels used to represent each block of the QR code by a pre-defined factor.

8. A method according to claim 1, wherein combining the QR code with an image includes converting the pixel data of the image to HSL (hue, saturation, lightness) color representation.

9. A method according to claim 1, wherein the received QR code comprises a first QR code and the image comprises a second QR code which is spatially offset from the first QR code by a pre-defined offset, relative to a timing pattern of the first QR code;
and the method comprises, for each of the first set of blocks, replacing an outer pixel of each block of the first QR code with a pixel representing a central pixel of a block of the second QR code.

10. A tangible machine-readable medium, including a set of instructions which when executed by a processor cause the processor to:
receive a graphic code including a plurality of dark blocks and a plurality of light blocks representing encoded data;
represent each encoded data block as an array of pixels including a central pixel, or a plurality of central pixels, and a plurality of border pixels, wherein the border pixels surround the central pixels;
replace pixel data of the border pixels with corresponding pixel data from an image having the same dimensions as the graphic code; and
replace pixel data of the central pixels with modified corresponding pixel data from the image;
wherein modifying the corresponding pixel data from the image includes applying a lightness threshold to the image pixel data, wherein for replaced central pixels located in a dark block of the graphic code, the lightness threshold comprises a first lightness threshold, which defines a maximum lightness level, and for replaced central pixels located in a light block of the graphic code, the lightness threshold comprises a second lightness threshold, which defines a minimum lightness level.

11. A tangible machine-readable medium according to claim 10, further including instructions to:
detect a plurality of dark blocks and a plurality of light blocks of the graphic code that represent a function pattern;
associate a third lightness threshold with dark blocks of the function pattern and associate a fourth lightness threshold with light blocks of the function pattern;
replace pixel data of the function patterns with modified corresponding pixel data from the image, wherein modifying the corresponding pixel data from the image includes applying the associated third and fourth lightness thresholds to image pixel data at locations corresponding to the function pattern.

12. A tangible machine-readable medium according to claim 11,
wherein the third lightness threshold defines a maximum lightness level for dark blocks and is set at a lower lightness level than the first lightness threshold; and
wherein the fourth lightness level defines a minimum lightness level for light blocks and is set at a higher lightness level than the second lightness threshold.

13. An apparatus comprising:
an image processing module to:
receive a quick response (QR) code and an image; wherein each pixel location of the QR code corresponds to a pixel location of the image;
for each of a first set of blocks of the QR code, define a central pixel or a plurality of central pixels, and a plurality of outer pixels, wherein the outer pixels surround the central pixels; and
combine the QR code with the image, wherein combining the QR code with the image includes:
for pixel locations corresponding to outer pixels, using pixel data of the image as combined pixel data;
for pixel locations corresponding to central pixels, applying a lightness threshold to the pixel data of the image to provide combined pixel data, wherein the lightness threshold is based on whether that location corresponds to a light block or a dark block of the QR code;
the apparatus further comprising a printer to print the combined image and QR code.

14. An apparatus according to claim 13, wherein applying the lightness threshold comprises:
for a central pixel of a dark block of the first set, applying a maximum lightness threshold by adjusting a lightness level of image pixels with a lightness level above the maximum lightness threshold to be below or equal to the maximum lightness threshold;
for a central pixel of a light block of the first set, applying a minimum lightness threshold by adjusting a lightness level of image pixels with a lightness level below the minimum lightness threshold to be above or equal to the minimum lightness threshold.

15. An apparatus according to claim 13, wherein the image processing module is to:
define a first plurality of blocks representing encoded data as the first set of blocks and define a second plurality of blocks representing a function pattern as a second set of blocks;
wherein combining the QR code with the image includes:
for pixel locations corresponding to dark blocks of the second set of blocks, applying a maximum lightness threshold, which is lower than the maximum lightness threshold associated with the first set of blocks;
for pixel locations corresponding to light blocks of the second set of blocks, applying a minimum lightness threshold, which is higher than the minimum lightness threshold associated with the first set of blocks.
